(19) United States
(12) Patent Application Publication
(10) Pub. No.: US 2021/0062796 A1
(43) Pub. Date: Mar. 4, 2021

(54) VIBRATOR AND PUMP

(71) Applicants: SALMAN ABU AWAD, BOKATTA (IL); MHDE ABU AWAD, BOKATTA (IL)

(72) Inventors: SALMAN ABU AWAD, BOKATTA (IL); MHDE ABU AWAD, BOKATTA (IL)

(21) Appl. No.: 16/960,095

(22) PCT Filed: Jan. 8, 2019
(86) PCT No.: PCT/IL2019/050042

§ 371 Date: Jul. 6, 2020

Related U.S. Application Data
(60) Provisional application No. 62/620,994, filed on Jan. 23, 2018.

(51) Int. Cl. F04B 9/06; F03G 3/06; F04B 53/14; F04B 53/16

(52) U.S. Cl. CPC F04B 9/06; F04B 53/16; F04B 53/14; F03G 3/06

(57) ABSTRACT

A vibrator(56A), including: a bar(16), a first location(64A) therealong including a first pivotal connection(20A) to the chassis(62) of the vibrator; a weight(14) including a second pivotal connection(20B) to a second location(64B) of the bar(16); and a motor(12), for rotating(70) the weight(14) about the second pivotal connection(20B), thereby converting the weight rotation(70) to back and forth linear motion(54), thereby the back and forth linear motion(54) is characterized by the distance between the first(64A) and second(64B) locations.

### TECHNICAL FIELD

The invention relates to the fields of vibrators and pumps.

### BACKGROUND

There is a long felt need to provide a pump being not vulnerable to obstacles, which might block the motor thereof.

There is along felt need to provide a motorized vibrator, for providing improved low-cycled linear motion.

Further, current off-grid systems require fuel power or large number of solar panels, with very low efficiency which makes them economically inefficient.

There is a long need for improving the efficiency of water pumps and hydraulic compressors (air and fluids).

### SUMMARY

In one aspect, the invention is directed to a vibrator, including:
a bar;
a weight being pivotally connected to the bar; and
a motor.

### BRIEF DESCRIPTION OF THE DRAWINGS

FIG. 1 is a front sectional view of a pump according to one embodiment, at the inhaling state.

FIG. 2 is the front sectional view the pump of FIG. 1 at the exhaling state.

FIG. 3 depicts the pump of FIG. 1 at the exhaling state of FIG. 2, including as well the mechanism of moving the piston rod.

FIG. 4 depicts the inhaling state of FIG. 1, being induced by the mechanism of FIG. 3.

FIG. 5 depicts the mechanical principle of the vibrating mechanism of FIG. 3.

FIG. 6 is front view of the pump of FIG. 3.

FIG. 7 is perspective view of the pump of FIG. 3.

FIG. 8 is a vibrator and pump according to another embodiment.

### DETAILED DESCRIPTION

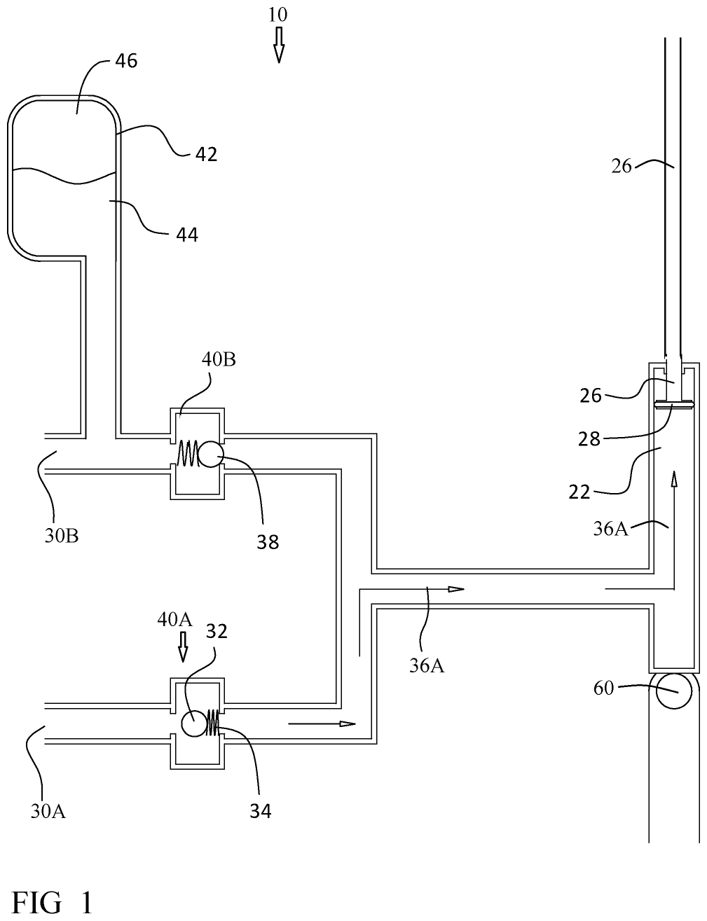

FIG. 1 is a front sectional view of a pump according to one embodiment, at the inhaling state.

A pump 10 includes a piston 28, extending from a piston rod 26, for being pulled, for inhaling, as shown by arrow 36A, from inlet 30A. Inhaling 36A from inlet 30A into cylinder 22 is allowed by one-way valve 40A, while inhaling from outlet 30B into cylinder 22 is disallowed by one-way valve 40B.

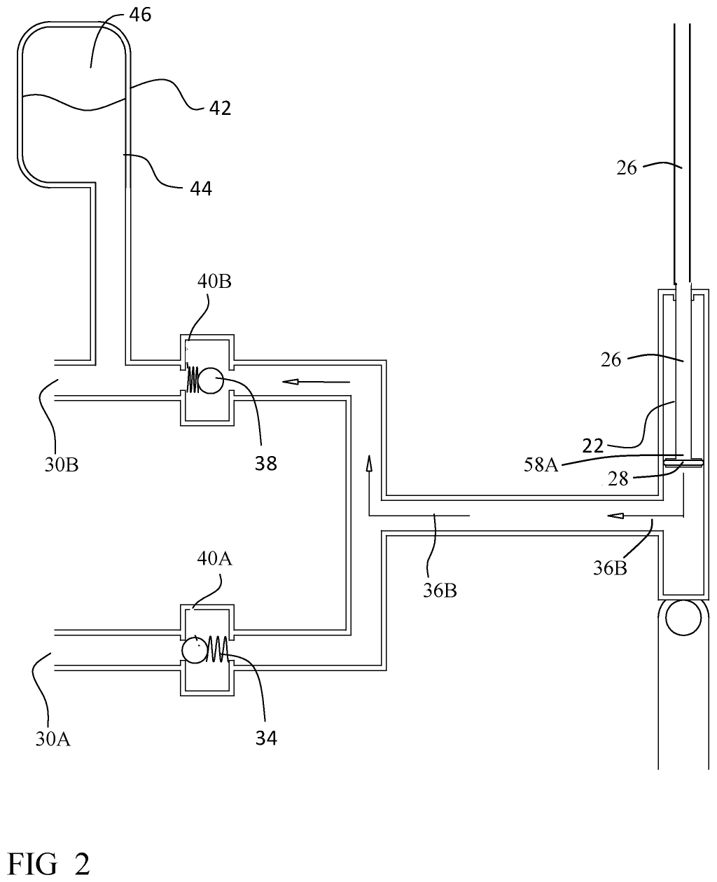

FIG. 2 is the front sectional view the pump of FIG. 1 at the exhaling state.

Piston 28 may be pressed as shown by arrow 36B, for exhaling, towards outlet 30B. Exhaling 36B towards outlet 30B from cylinder 22 is allowed by one-way valve 40B, while exhaling towards inlet 30A from cylinder 22 is disallowed by one-way valve 40A.

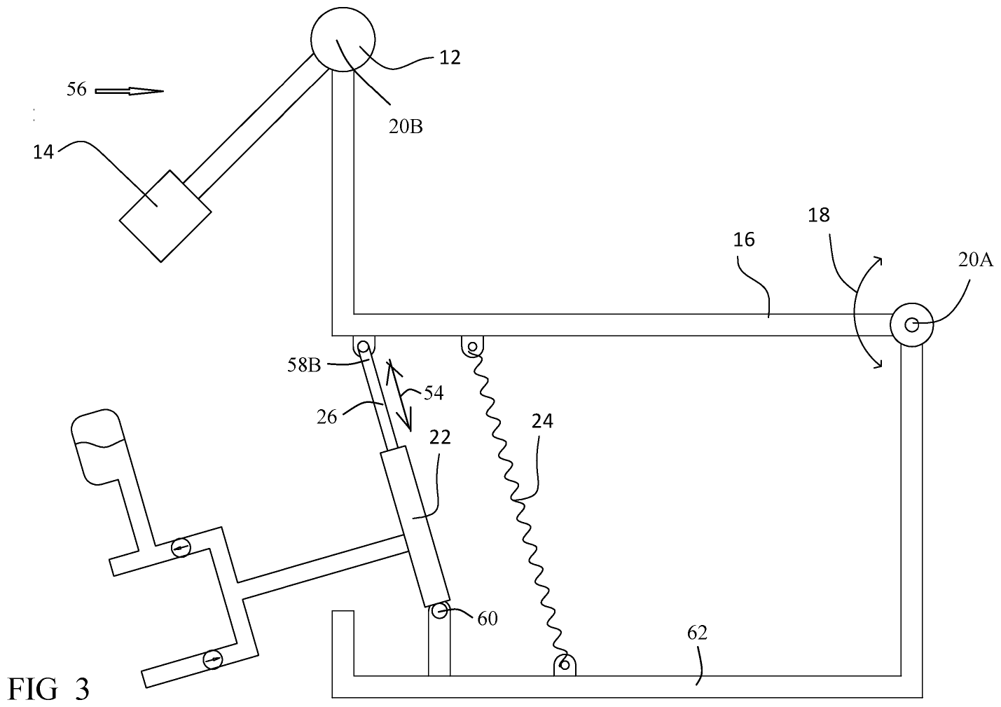

FIG. 3 depicts the pump of FIG. 1 at the exhaling state of FIG. 2, including as well the mechanism of moving the piston rod.

The other end 58A of piston rod 26 is pivotally connected to an elongated bar 16, being rotatable, by a hinge 20A, in relation to cylinder 22.

Bar 16 is actively rotated back and forth, as shown by arrow 18, in relation to a base 62 being pivotally connected to cylinder 22 by a pivot 60, thereby pressing and pulling piston rod 26 back and forth, as shown by arrow 54, thereby toggling between the inhaling and the exhaling states of FIG. 1 and FIG. 2 back and forth.

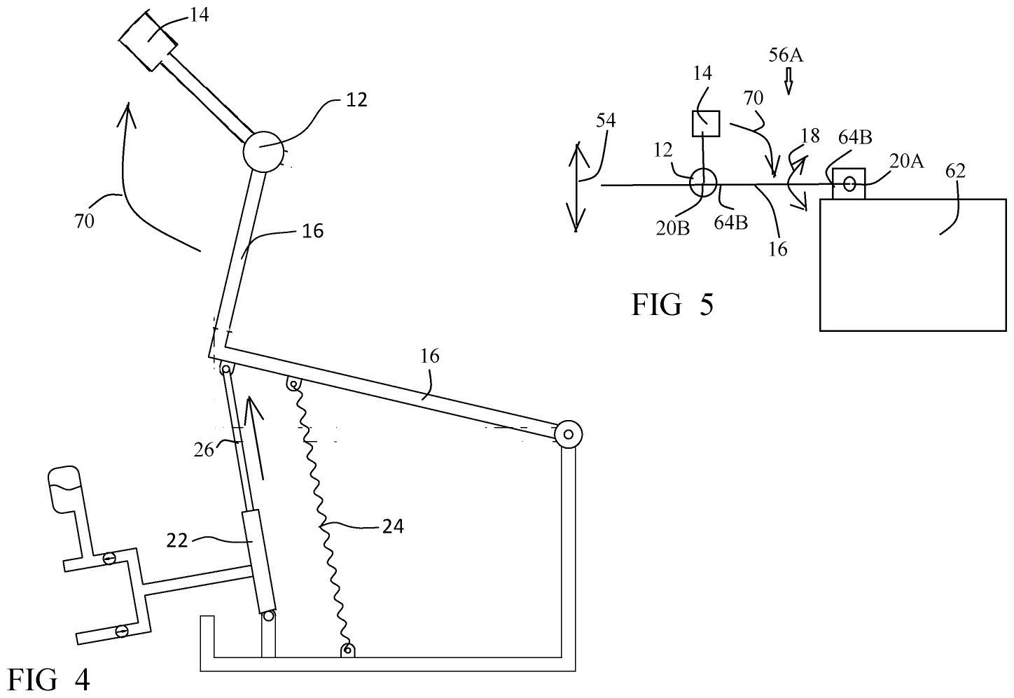

FIG. 4 depicts the inhaling state of FIG. 1, being induced by the mechanism of FIG. 3.

Motor 12 upon rotating rotation 70 lifts weight 14, thus lifts bar 16, by rotating it in relation to cylinder 12, thus pulls piston rod 26, thus applies the inhaling state.

Pump 10 as using the vibrator of mechanism 56A, is advantaged in that there is no physical braking or blocking to motor 12, thus increasing its durability.

FIG. 5 depicts the mechanical principle of the vibrating mechanism of FIG. 3.

Thus, mechanism 56A constitutes a vibrator, including bar 16, one end 20A thereof being rotatable in relation to chassis 62; and a weight 14, being pivotally connected to a given location 64B along elongated bar 16, such as through a base bar 17 of motor 12, and a motor 12 for continuously rotating weight 14 in relation to elongated bar 16. Bar 16 together with hinge 20A convert rotation 70 to linear motion 54 back and forth.

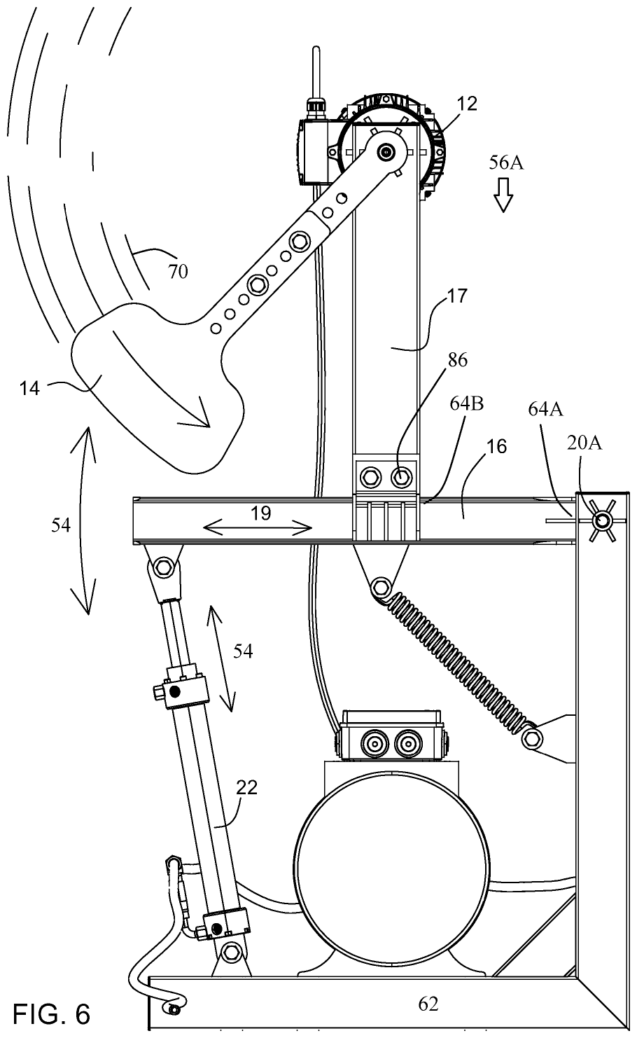

FIG. 6 is front view of the pump of FIG. 3.

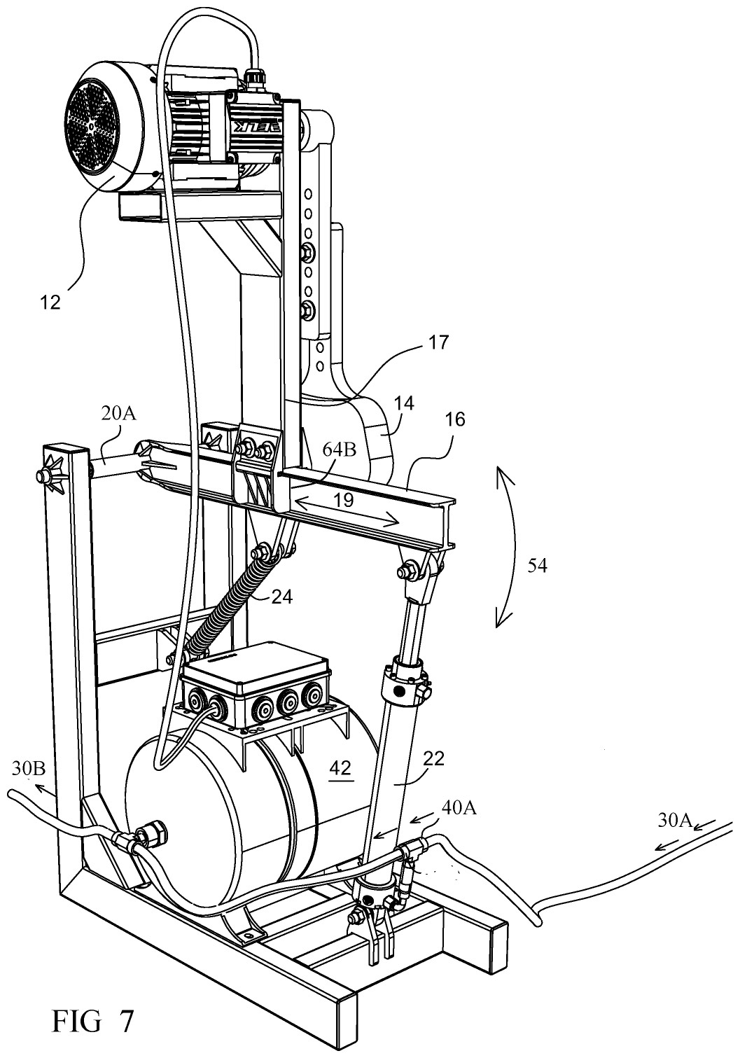

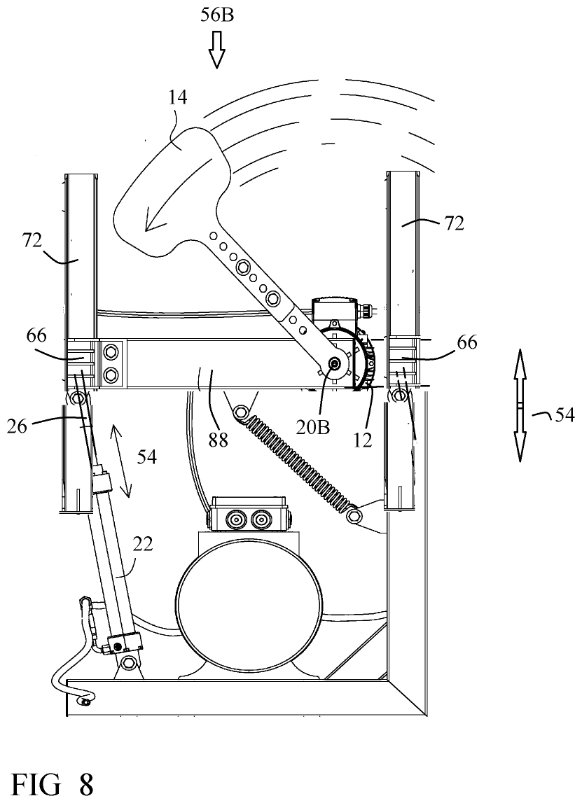

FIG. 7 is perspective view of the pump of FIG. 3.

Bar 16 functions as a lever, being characterized by its length. Location 64B along bar 16 may be adjusted, as shown by arrow 19, for adjusting the length of the lever, thereby adjusting the force and rate of the back and forth motion thereof.

FIG. 8 is a vibrator and pump according to another embodiment.

According to the embodiment of FIG. 8, weight 14 as well is rotated by motor 12, and the resulting motion is as well linear back and forth motion 54. However, the mechanism 56B providing conversion of rotation 70 to linear back and forth motion 54 is obtained by connecting piston rod 26 to a cart 88 being driven by weight 14, and limiting the driving within tracks 72 via bearings 66.

Mechanism 56A is advantaged over 56B in the lever principle, allowing adjusting the length thereof, for adjusting the cycle and force.

Mechanism 56B is further disadvantaged in energy loss of by track 72.

Thus, rather than the prior art direct delivery using a crank for converting the circular motion to linear motion, vibrator 56A improves the delivery of the power from the motor or the power source, to the piston, being the output.

The delivery improvement is by vibrator 56A increasing the speed of weight 14, and the structure delivering its energy to the piston at a specific location, by adding the centrifugal and gravitational energy one to the other, and then further circulating by the power of the motor.
10: pump according to one embodiment of invention;
12: hinge and motor for rotating round hinge;
14: weight;
17: base bar;
18: rotation of bar 16 in relation to chassis 62;
19: adjustment of the location of weight 14 along bar 16;
20A,20B: hinges/ pivotal connections;
22: cylinder;
24: spring, for accompanying the back and forth movement/rotation of bar 16;
26: piston rod;
28: piston;
30A: inlet of pump;
30B: outlet of pump;
32: ball sealer;
34: spring for pressing ball sealer 34;
36A,36B: inhaling and exhaling respectively;
40A,40B: inhaling and exhaling one-way valves respectively;
42: stabilizing compartment;
44: water or liquid;
46: air;
54: back and forth linear motion provided by the vibrator, being as well the sliding of piston rod 26 in relation to cylinder 22;
56A: vibrator, being a mechanism for moving bar 16 back and forth;
56B: another vibrator, being another mechanism for moving back and forth;
58A and 58B denote ends of piston rod 26;
60: pivot;
62: base/chassis;
64A,64B: locations along bar 16;
66: bearing;
70: rotation of weight 14;
72: track;
88: cart for being driven linearly back and forth.

The reference numbers in the claims should not be interpreted as limiting the claims in any form.

What is claimed is:

1. A vibrator(56A), comprising:
a bar(16), a first location(64A) therealong comprising a first pivotal connection(20A) to a chassis(62) of said vibrator(56A);
a weight(14) comprising a second pivotal connection(20B) to a second location(64B) of said bar(16); and
a motor(12), for rotating(70) said weight(14) about said second pivotal connection(20B),
thereby converting said weight rotation(70) to back and forth linear motion(54),
thereby said back and forth linear motion(54) is characterized by a distance between said first(64A) and second(64B) locations.

2. The vibrator(56A) of claim 1, further comprising:
adjusting means(86), for adjusting(19) said distance between said first(64A) and second(64B) locations.

3. A pump(10), comprising:
a piston(28) being slideable(54) within a cylinder(22); and
a vibrator(56A), for sliding said piston(28) back and forth within said cylinder(12), for pumping thereby, thereby a motor(12) of said vibrator(56A) is durable to physical blocking of said piston(28).

4. The pump(10) of claim 3, wherein said vibrator comprises:
a bar(16), a first location(64A) therealong comprising a first pivotal connection(20A) to a chassis(62);
a weight(14) comprising a second pivotal connection(20B) to a second location(64B) of said bar(16),
wherein said motor(12) is configured for rotating(70) said weight(14) about said second pivotal connection(20B), thereby converting said weight rotation(70) to back and forth linear motion(54) characterized by a distance between said first(64A) and second(64B) locations.

5. The pump(10) of claim 3, further comprising:
adjusting means(86), for adjusting(19) said distance between said first(64A) and second(64B) locations.

6. The pump(10) of claim 3, further comprising:
an inlet(30A) comprising a first one-way valve(40A), for allowing inhaling only from said inlet(30A); and
an outlet(30B) comprising a second one-way valve(40B), for allowing exhaling only towards said outlet(30B).

7. The pump(10) of claim 6, further comprising:
a compartment(42) communicating with said inlet(30A), thereby stabilizing said pumping.

8. The vibrator(56A) of claim 1, wherein said rotation of said motor(12), for rotating(70) said weight(14) about said second pivotal connection(20B), consists of one member selected from a group consisting of clockwise direction, counter clockwise direction.

9. The vibrator(56A) of claim 1, wherein said motor(12) comprises at least one member selected from a group consisting of electric motor, water turbine motor, combustion motor, heat motor, molecular motor.
